(19) United States
(12) Patent Application Publication
(10) Pub. No.: US 2011/0221382 A1
(43) Pub. Date: Sep. 15, 2011

(54) MOTOR CONTROL METHOD AND APPARATUS AND ELECTRIC POWER STEERING SYSTEM

(75) Inventor: Yoshitaka HAYASHI, Obu-city (JP)

(73) Assignee: DENSO CORPORATION, Kariya-city (JP)

(21) Appl. No.: 13/042,674

(22) Filed: Mar. 8, 2011

(30) Foreign Application Priority Data
Mar. 9, 2010 (JP) 2010-51584

(51) Int. Cl. H02P 27/04

(52) U.S. Cl. 318/801

(57) ABSTRACT

In a motor control method for driving a three-phase motor by an inverter, a dead time compensation operation is performed to compensate for output voltage loss caused by a dead time, in which both a high-side FET and a low-side FET in the inverter are turned off. For example, in a range between 0° and 60° and a range between 120° and 180°, a reference value is provided stepwise to a PWM command value of a U-phase. In a range between 60° and 120°, a doubled reference value is provided stepwise to the PWM command value. A compensated PWM voltage is supplied to the inverter. The stepwise change at zero-cross points, 0° and 180°, is reduced relative to a case, in which a fixed dead time compensation value is provided in a range between 0° and 180°. Torque ripple near the zero-cross point is thus suppressed.

### CROSS REFERENCE TO RELATED APPLICATION

This application is based on and incorporates herein by reference Japanese patent application No. 2010-51584 filed on Mar. 9, 2010.

### FIELD OF THE INVENTION

The present invention relates to a motor control method and a motor control apparatus, which perform dead time compensation of a motor driven by an inverter. The present invention also relates to an electric power steering system using such a control method and a control apparatus.

### BACKGROUND OF THE INVENTION

A voltage-type PWM inverter has conventionally been used as a drive apparatus for a three-phase motor. The voltage-type PWM inverter generally has an inverse transformation circuit including high-side arms and low-side arms. Each high-side arm is formed of a high-side FET, which is a switching element at a power supply voltage side (high potential side). Each low-side arm is formed of a low-side FET, which is a switching element at a ground side (low potential side).

If both the high-side FET (field-effect transistor) and the low-side FET in each phase are turned on at the same time, a short-circuit arises. Therefore, the high-side FET and the low-side FET are switching-controlled normally so that one is turned on when the other is turned off. However, a short time delay arises at the time of switching between turning on and off. Therefore both the high-side FET and the low-side FET are tuned off for a short time so that the high-side FET and the low-side FET are not turned on at the same time even if momentarily. This short time, in which the high-side FET and the low-side FET are prevented from short-circuiting, is a short-circuit prevention time or a dead time. Since this dead time causes loss of an output voltage of the inverter, an error arises between a PWM command value and the output voltage actually produced by the inverter. Dead time compensation is therefore required to compensate for the loss of the output voltage, which is caused by the dead time.

As a dead time compensation control method, it is proposed to improve response characteristic of a current loop in PI control (proportional and integral feedback control) or to add/subtract a dead time compensation value to and from the PWM command value applied to the inverter. Addition/subtraction of the dead time compensation value relative to the PWM command value is disclosed in the following patent document 1, for example.
Patent document 1: JP 2002-95262A

According to the dead time compensation by improving the response characteristic of the current loop in the PI control, the motor, which is PI-controlled, is likely to vibrate and generate abnormal sound, because noise component is increased if the loop gain in feedback control is increased. In case that the motor is located near passengers in a vehicle compartment as in an electric power steering system for a vehicle, for example, it is not possible to suppress vibration and abnormal sound and to perform the dead time compensation control sufficiently at the same time.

According to the addition/subtraction of the dead time compensation value to and from the PWM command value, polarity of the dead time compensation value is reversed in step generally at a zero-cross point in an output current of the inverter. In case that the output current is expressed as a sine waveform I×sin θe relative to an electric angle θe as shown in FIG. 13A for example, the polarity of the output current is positive in a range of electric angle between 0° and 180° and negative in a range between 180° and 360°. The zero-cross point is at 0° and 180°, at which the polarity is reversed. The dead time compensation value is set to a positive value DV in the range, in which the electric angle θe is between 0° and 180°. The dead time compensation value is set to a negative value −DV in the range, in which the electric angle θe is between 180° and 360°. The dead time compensation value changes stepwise at the zero-cross points 0° and 180°.

If the dead time compensation value is increased to provide sufficient compensation, ripple (pulsation) of the output current increases near the zero-cross point. If the ripple of the output current is suppressed, sufficient compensation value is not provided. The ripple in the output current results in torque ripple in a motor. If a motor is applied to an electric power steering system, which assists steering operation of a vehicle, the torque ripple affects stability of steering wheel operation of a driver and becomes an important factor, which affects merchantability of the electric power steering system.

The patent document 1 proposes a method of reducing ripple in an output current near a zero-cross point. According to this method, as shown in FIG. 13B, if the output current is in a small current range, which is less than a threshold value Ix, a dead time compensation value is determined as a product of a dead time compensation value in a range, in which the output current is greater than the threshold value Ix, and a compensation coefficient k (0≦k≦1). According to this method, the dead time compensation value becomes too small in a small output current range.

### SUMMARY OF THE INVENTION

It is therefore an object of the present invention to provide a motor control method and a motor control apparatus, which reduce torque ripple near a zero-cross point in dead time compensation control, while realizing sufficient dead time compensation. It is another object of the present invention to provide an electric power steering system, which reduces torque ripple and generation of vibration and abnormal sound.

According to one aspect of the present invention, a motor control method is provided for compensating an error voltage, which is caused between a PWM command value and an output voltage by a dead time of a voltage-type inverter for driving a three-phase AC motor. The motor control method is performed by the following steps (1) to (6). The step (1) acquires a predetermined parameter ψ(θe) of each of three phases represented by sine waveforms, which have same amplitudes relative to a central value 0 and phases having phase differences of 120° one another in correspondence to a phase of electric angle. The parameter is calculated based on the electric angle of the motor in advance of generation of a PWM voltage. The step (2) sets a first dead time compensation value, which is two times as large as a predetermined reference value, to increase the PWM command value of one phase in a case of a first condition that the parameter of the one phase is greater than 0 and the parameters of other two phases are both less than 0. The step (3) sets a second dead time compensation value, which is set to be two times as large as the predetermined reference value, to decrease the PWM command value of the one phase in a case of a second condition that the parameter of the one phase is less than 0 and the parameters of the other two phases are both greater than 0. The step (4) sets a third dead time compensation value, which is as large as the predetermined reference value, to increase the PWM command value of the one phase in a case that the parameter of the one phase is greater than 0 but different from the first condition. The step (5) sets a fourth dead time compensation value, which is as large as the predetermined reference value, to decrease the PWM command value of the one phase in a case that the parameter of the one phase is less than 0 but different from the second condition. The step (6) outputs to the inverter a compensated PWM voltage, which is determined by compensating the PWM command value by one of the first to the fourth dead time compensation values in correspondence to the parameter.

According to another aspect of the present invention, a motor control method is provided for compensating an error voltage, which is caused between a PWM command value and an output voltage by a dead time of a voltage-type inverter for driving a three-phase AC motor having a U-phase, a V-phase and a W-phase. The motor control method is performed by the following steps (1) to (6′). The step (1′) acquires an electric angle of each of the U-phase, the V-phase and the W-phase, assuming that phase currents of the U-phase, the V-phase and the W-phase have same amplitudes relative to a central value 0, a sine waveform of a U-phase current increases from 0 at an electric angle 0°, a V-phase current is delayed 120° relative to the U-phase current and a W-phase current advances 120° relative to the U-phase current, and further assuming that the electric angle is divided into a first range, a second range, a third range, a fourth range, a fifth range and a sixth range, which are between 0° and 60°, between 60° and 120°, between 120° and 180°, between 180° and 240°, between 240° and 300° and between 300° and 360°, respectively. The second step (2′) sets a first dead time compensation value, which is two times as large as a predetermined reference value to increase the PWM command value of the U-phase in the second range, the PWM command value of the V-phase in the fourth range and the PWM command value of the W-phase in the sixth range, respectively. The step (3′) sets a second dead time compensation value, which is two times as large as the predetermined reference value, to decrease the PWM command value of the U-phase in the fifth range, the PWM command value of the V-phase in the first range and the PWM command value of the W-phase in the third range, respectively. The step (4′) sets a third dead time compensation value, which is as large as the predetermined reference value, to increase the PWM command value of the U-phase in the first range and the third range, the PWM command value of the V-phase in the third range and the fifth range and the PWM command value of the W-phase in the fifth range and the first range, respectively. The step (5′) sets a fourth dead time compensation value, which is as large as the predetermined reference value, to decrease the PWM command value of the U-phase in the fourth range and the sixth range, the PWM command value of the V-phase in the sixth range and the second range and the PWM command value of the W-phase in the second range and the fourth range, respectively. The step (6′) outputs to the inverter a compensated PWM voltage, which is determined by compensating the PWM command value by one of the first to the fourth dead time compensation values corresponding to the range of electric angle.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram of a motor control apparatus according to an embodiment of the present invention;

FIG. 2 is a schematic diagram of an electric power steering system, to which the motor control apparatus according to the embodiment of the present invention is applied;

FIG. 3 is a basic circuit diagram of the motor control apparatus according to the embodiment of the present invention;

FIG. 4 is a flowchart of a motor control method according to a first embodiment of the present invention;

FIG. 5 is a waveform diagram of a dead time compensation value provided in the motor control method according to the first embodiment of the present invention;

FIG. 6 is a waveform diagram of a PWM voltage provided in the motor control method according to the first embodiment of the present invention;

FIG. 7 is a waveform diagram of a dead time compensation value provided in a motor control method according to a comparative example;

FIG. 8 is a waveform diagram of a PWM voltage provided in the motor control method according to the comparative example;

FIG. 9 is an explanatory graph showing a relation between an electric angle and three dead time compensation values;

FIG. 10 is a flowchart of a motor control method for a U-phase according to a second embodiment of the present invention;

FIG. 11 is a flowchart of a motor control method for a V-phase according to the second embodiment of the present invention;

FIG. 12 is a flowchart of a motor control method for a W-phase according to the second embodiment of the present invention;

FIG. 13A is an explanatory diagram showing one conventional dead time compensation method; and

FIG. 13B is an explanatory diagram showing another conventional dead time compensation method.

### DETAILED DESCRIPTION OF THE PREFERRED EMBODIMENT

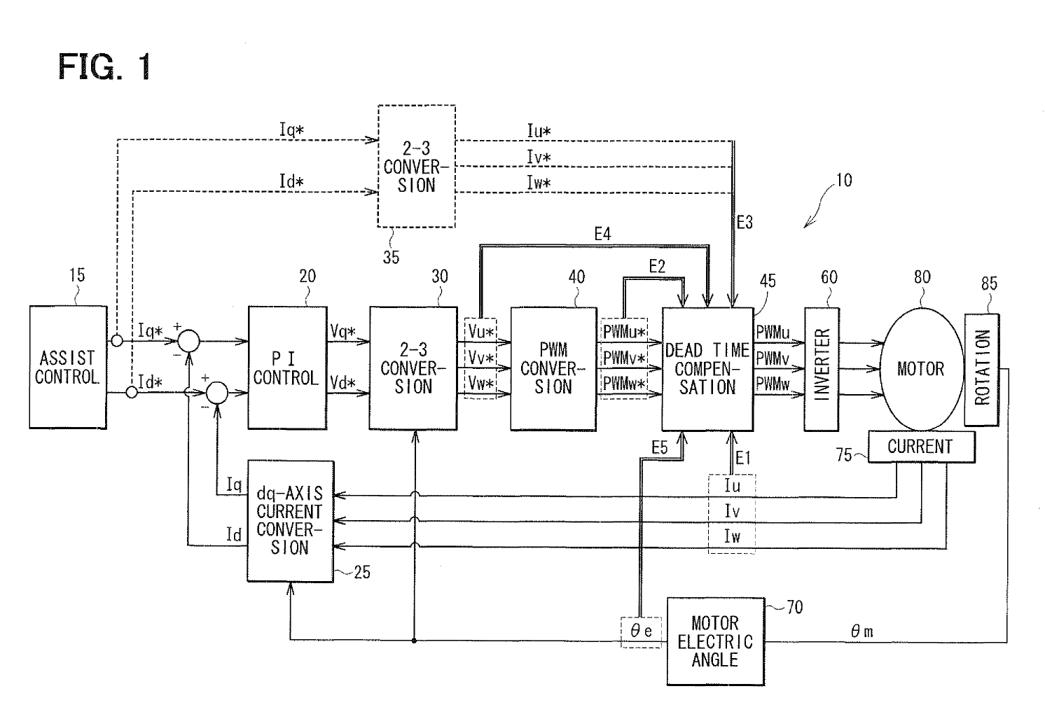

The present invention is described with reference an embodiment, in which a motor control apparatus shown in FIG. 1 is used in an electric power steering system 1, which assists steering operation of a vehicle.

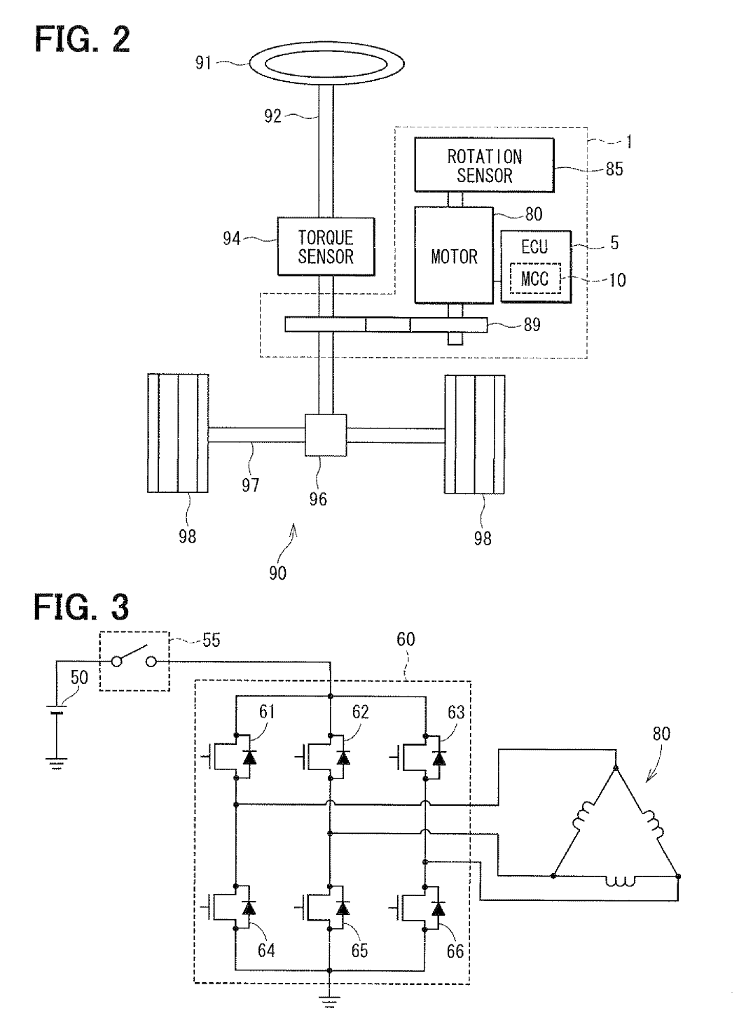

As shown in FIG. 2, the electric power steering system 1 is provided in a steering system 90, which includes a steering wheel 91 and a steering shaft 92 coupled to the steering wheel 91. A torque sensor 94 is attached to the steering shaft 92 to detect steering torque. A pinion gear 96 is attached to one end of the steering shaft 92 and engaged with a rack shaft 97. A pair of tire wheels 98 is coupled rotatably to both ends of the rack shaft 97 via tie rods and the like. The rotary motion of the steering shaft 92 is translated into linear motion of the rack shaft 97 by the pinion gear 96. The wheels 98 are steered by an angle corresponding to the amount of the linear motion of the rack shaft 97.

The electric power steering system 1 includes a motor 80 for generating steering assist torque, a rotation angle sensor 85 for detecting a rotation angle of the motor 80, a reduction gear 89 for reducing rotation of the motor 80 and transferring the reduced rotation to the steering shaft 92 and an ECU (electronic control unit) 5. The ECU 5 includes a motor control circuit (MCC) 10, which controls driving of the motor 80. The motor 80 is a three-phase brushless motor, which drives the reduction gear 89 to rotate in both forward and reverse directions. According to this configuration, the electric power steering system 1 generates steering assist toque for assisting the steering operation of the steering wheel 91 and transfers it to the steering shaft 92.

The motor control circuit 10 has a basic circuit configuration shown in FIG. 3. A power supply relay 55 is provided to conduct or interrupt power supply from a DC power source 50 to an inverter 60. The inverter 60 generates three-phase AC power from DC power. The motor 80 is driven with the three-phase AC power supplied from the inverter 60.

The inverter 60 is a voltage-type PWM inverter and includes an inverse conversion circuit, which has high-side arms and low-side arms. The high-side arms are formed of three high-side FETs 61, 62 and 63, which are switching elements at a power supply side (high potential side). The low-side arms are formed of three low-side FETs 64, 65 and 66, which are switching elements at a ground side (low potential side). The high-side FET 61 and the low-side FET 64 are connected in series in one pair and supply electric power to a U-phase coil of the motor 80. The high-side FET 62 and the low-side FET 65 are connected in series in another pair to supply electric power to a V-phase coil of the motor 80. The high-side FET 63 and the low-side FET 66 are connected in series in the other pair and supply electric power to a W-phase coil of the motor 80.

If the high-side FET 61 and the low-side FET 64, the high-side FET 62 and the low-side FET 65 or the high-side FET 63 and the low-side FET 66 turn on at the same time, a short-circuit arises. Therefore, the high-side FET and the low-side FET in each pair are switched over normally such that one is turned on and the other is turned off. However a short time delay arises at the time of switching over between the turning-on and the turning-off of each FET. For this reason, a dead time is provided as a shorting prevention time to turn off both the high-side FET and the low-side FET in each pair so that both the high-side FET and the low-side FET are prevented from being turned on at the same time momentarily.

The motor control circuit 10 is shown in detail in FIG. 1, in which a plurality of software calculation functions is shown as corresponding calculation sections. An assist control calculation section 15 is provided to output a q-axis current command value Iq* and a d-axis current command value Id* based on a steering torque detection value of the torque sensor 94 and a vehicle speed detection value of a vehicle speed sensor (not shown).

A PI control calculation section 20 is provided to calculate and output a q-axis voltage command value Vq* and a d-axis voltage command value Vd* by proportional and integral control based on a difference between the q-axis current command value Iq* and a q-axis current value Iq and a difference between the d-axis current command value Id* and a d-axis current value Id. A dq-axis current conversion calculation section 25 is provided to feedback the q-axis current value Iq and the d-axis current value Id. A current sensor 75 is provided to detect actual phase currents flowing in the motor 80 and output phase current detection values Iu, Iv and Iw, which are DQ-converted into the q-axis current value Iq and the d-axis current value Id by the dq-axis current conversion calculation section 25. The q-axis current is a torque current, and the d-axis current is an excitation current or field current.

A 2-3 phase conversion calculation section 30 is provided to convert two-phase voltage command values, which are the q-axis voltage command value Vq* and the d-axis voltage command value Vd*, into three-phase voltage command values, which are a U-phase voltage command value Vu*, a V-phase voltage command value Vv* and a W-phase voltage command value Vw*. An electric angle θe is fed back to the 2-3 phase conversion calculation section 30 from the rotation angle sensor 85.

A PWM conversion calculation section 40 is provided to convert the three-phase voltage command values of the U-phase voltage command value Vu*, the V-phase voltage command value Vv* and the W-phase voltage command value Vw*, into duty command values, which are a U-phase PWM command value PWMu*, a V-phase PWM command value PWMv* and a W-phase PWM command value PWMw*, respectively.

A dead time compensation calculation section 45 is provided to determine dead time compensation values DVu, DVv and DVw in response to either of timing commands E1 to E5, which will be described below, and add or subtract them to and from the PWM command values PWMu*, PWMv* and PWMw*, respectively.

The inverter 60 generates the three-phase AC power by PWM voltages PWMu, PWMv and PWMw, which result from the addition or subtraction of the respective dead time compensation values. The current sensor 75 detects the actual phase currents of each phase and outputs the phase current detection values Iu, Iv and Iw.

The rotation angle sensor 85 detects a mechanical rotation angle θm of the motor 80 by taking one rotation of a rotor of the motor 80 as one cycle. A motor electric angle calculation section 70 is provided to convert the rotation angle θm to an electric angle θe. The electric angle θe is calculated by taking one cycle of an electric signal as a reference. If the number of poles of the motor 80 is four and the electric signal has a cycle period, which corresponds to the number of poles, the electric signal has four cycle periods in one mechanical rotation of the rotor of the motor 80.

The timing commands to the dead time compensation calculation section 45 are determined as follows. The timing command E1 is determined based on the phase current detection values Iu, Iv and Iw. The timing command E2 is determined based on the PWM command values PWMu*, PWMv* and PWMw*. The timing command E3 is determined based on the phase current command values Iu*, Iv* and Iw*. A 2-3 phase conversion calculation section 35 is provided to convert the q-axis current command value Iq* and the d-axis current command value Id* to the phase current command values Iu*, Iv* and Iw*. The timing command E4 is determined based on the phase voltage command values Vu*, Vv* and Vw*.

A phase current detection value I, a PWM: command value PWM*, a phase current command value I* and a phase voltage command value V* of each phase are predetermined parameters ψ(θe) as a function of the electric angle θe. The timing command E5 is determined based on the electric angle θe.

Two motor control methods are described below as a first embodiment and a second embodiment, respectively. The first embodiment uses the timing commands E1 to E4 and the second embodiment uses the timing command E5.

### First Embodiment

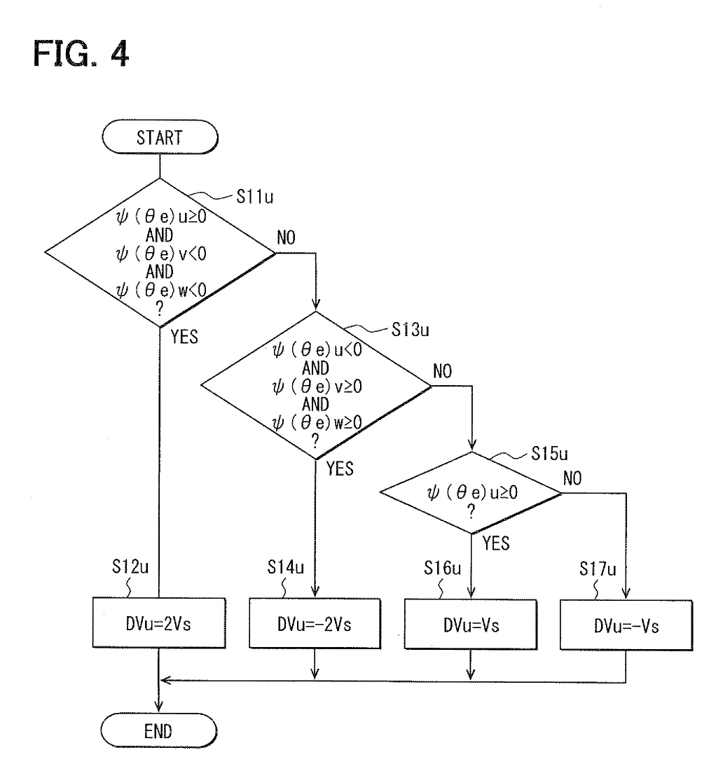

In the motor control method according to the first embodiment, the dead time compensation value DV for the U-phase is determined as shown in FIG. 4. In FIG. 4, symbol S denotes a step, symbol Vs denotes a reference value of the dead time compensation value and symbol 2Vs denotes a doubled compensation value, which is two times as large as Vs. The parameter ψ(θe)u is a function of the electric angle θe of the U-phase. Specifically, it corresponds to the phase current detection value Iu, the PWM command value PWMu*, the phase current command value Iu*, the phase voltage command value Vu* or the like.

At S11u, it is checked whether the parameter ψ(θe)u of the U-phase is equal to or greater than 0 and other two parameters ψ(θe)v of the V-phase and ψ(θe)w of the W-phase are both less than 0. If the check result of S11u is YES, a first dead time compensation value DVu is set to 2Vs at S12u. If the check result of S11u is NO, S13u is executed. At S13u, it is checked whether the parameter ψ(θe)u is less than 0 and the other two parameters W(θe)v and ψ(θe)w are both equal to or greater than 0. If the check result of S13u is YES, a second dead time compensation value DVu is set to −2Vs at S14u. If the check result of S13u is NO, S15u is executed. At S15u, it is checked whether the parameter ψ(θe)u is equal to or greater than 0. If the check result of S15u is YES, a third dead time compensation value DVu is set to Vs at S16u. If the check result of S15u is NO, a fourth dead time compensation value DVu is set to −Vs at S17u. By using the dead time compensation values 2Vs and Vs, which are set at S12u and S16u, the PWM command value of the U-phase is increased by addition of the positive compensation values 2Vs and Vs, respectively. By using the dead time compensation values −2Vs and −Vs, which are set at S14u and S17u, the PWM command value of the U-phase is decreased by addition of the negative compensation values −2Vs and −Vs, that is, by subtraction of 2Vs and Vs, respectively.

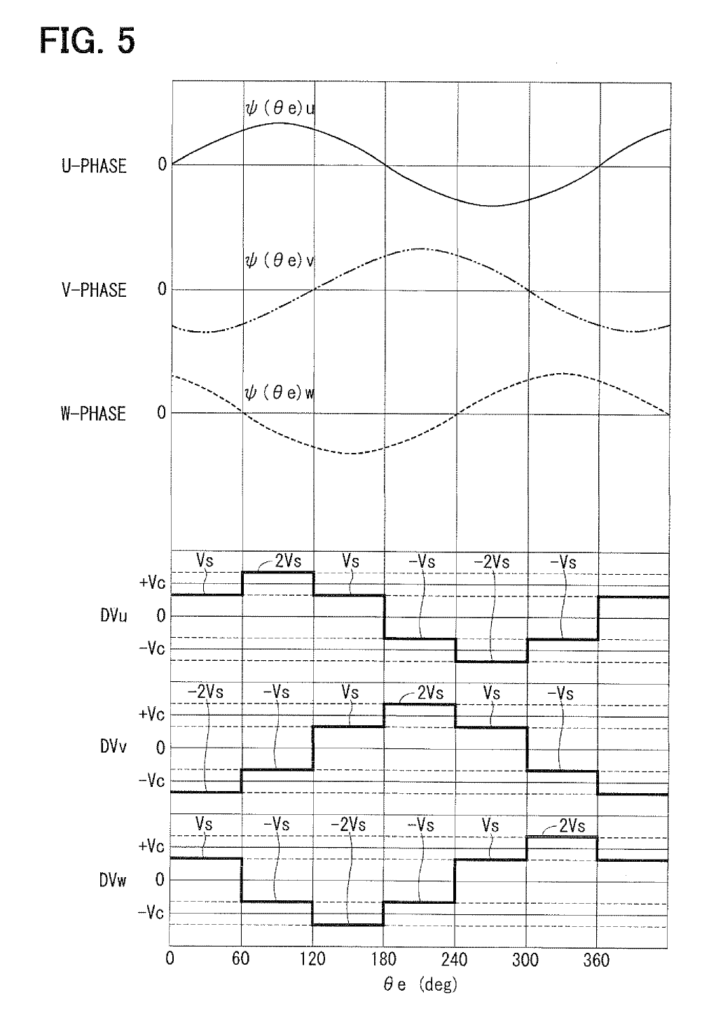

Other two dead time compensation values DVv and DVw for the V-phase and the W-phase are determined in the similar manner, respectively. The dead time compensation values DVu, DVv and DVw determined by the motor control method according to the first embodiment are thus changed as shown in FIG. 5. Specifically, the dead time compensation value DV of each phase is changed stepwise at every 60° in electric angle. The dead time phase values are changed with a phase difference of 120° among the three phases. The reference value Vs is about 2/3 of a theoretical dead time compensation value Vc as described below.

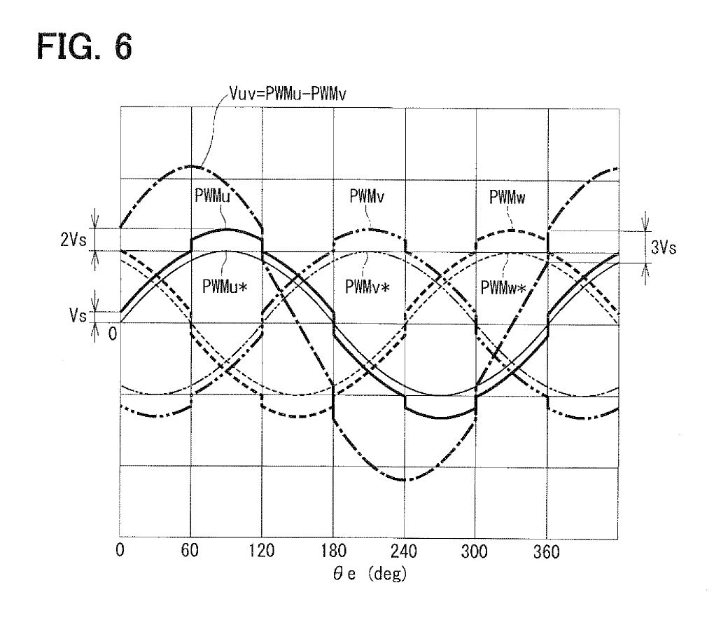

The PWM command value and the PWM voltage, which result from compensation of the PWM command value by the dead time compensation value, are shown in FIG. 6 with respect to each phase. For example, the PWM command value PWMu* of the U-phase is indicated by a fine solid line and the PWM voltage PWMu of the U-phase after the dead time compensation is indicated by a bold solid line. The PWM command value and the compensated PWM voltage of the V-phase are indicated similarly by two-dot chain lines. The PWM command value and the compensated PWM voltage of the W-phase are indicated similarly by dot lines. As a representative example, a motor inter-terminal voltage Vuv between the U-phase and the V-phase is indicated by a bold one-dot chain line. The motor inter-terminal voltage Vuv between the U-phase and the V-phase corresponds to a result of subtraction of the PWM voltage PWMv of the V-phase from the PWM voltage PWMu of the U-phase. This motor inter-terminal voltage Vuv is offset at electric angle points 0°) (360°, 120°, 180° and 300°. This offset value is 3Vs.

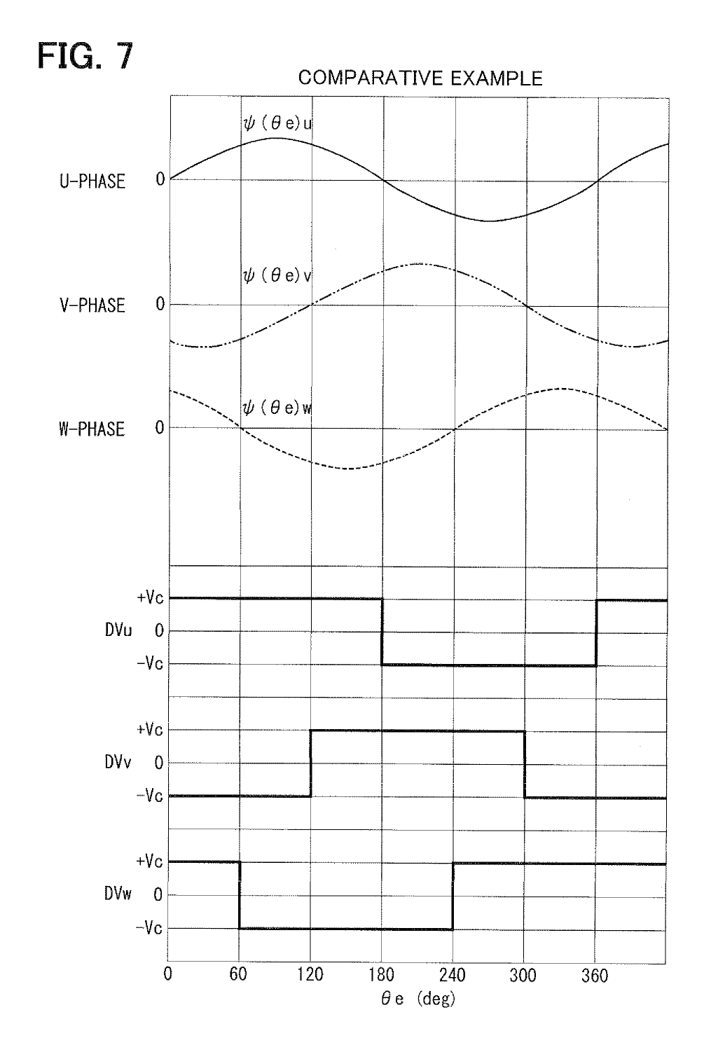

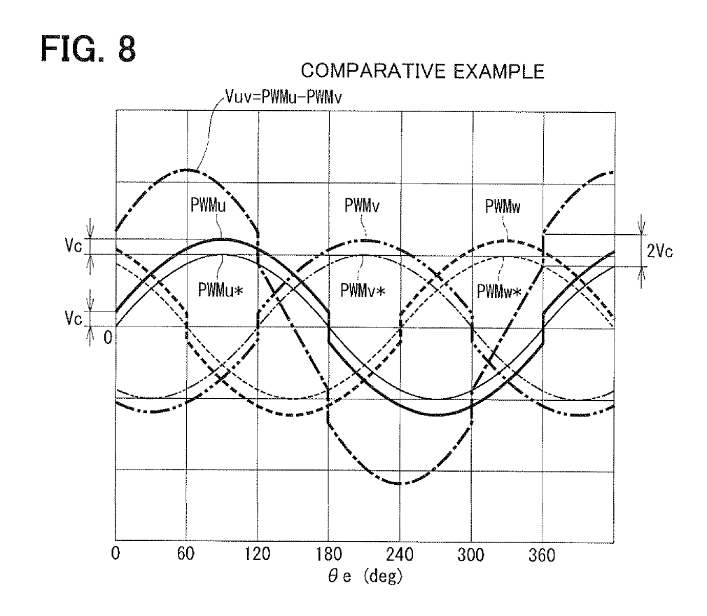

As a comparative example, another motor control method is described with reference to FIGS. 7 and 8. In the motor control apparatus according to the comparative example, a positive dead time compensation value DV of a fixed value is provided to a PWM command value PWM* when a parameter ψ(θe) is positive with respect to each phase. A negative dead time compensation value −DV is provided to the PWM command value PWM* when the parameter ψ(θe) is negative. The polarity of the parameter ψ(θe) changes twice in each cycle, that is, at every 180°. This point of polarity change is the zero-cross point. The dead time compensation value DV changes stepwise at the zero-cross point.

In the motor control method according to the comparative example, the dead time compensation value DV is set to a theoretical dead time compensation value Vc. The theoretical dead time compensation value Vc is determined by the following equation, in which “t,” “f” and “Vb” indicate a dead time, a PWM switching frequency and an inverter voltage, respectively.

Vc=t×f×Vb (1)

For example, if the dead time t is 1 μs and the PWM switching frequency f is 20 kHz, t×f is 0.02. That is, 2% of the inverter voltage Vb is lost by the dead time. Thus, an error arises between the PWM command value and the output voltage of the inverter. This 2% of the voltage corresponds to the theoretical dead time compensation value Vc.

The dead time compensation values DVu, DVv and DVw are provided by the motor control method according to the comparative example in a manner shown in FIG. 7, which is provided in correspondence to FIG. 5. FIG. 8 shows the PWM command value, the PWM voltage after having been provided with the dead time compensation value and the motor inter-terminal voltage Vuv between the U-phase and the V-phase in the similar manner shown in FIG. 6. The motor inter-terminal voltage Vuv between the U-phase and the V-phase in the comparative example is also offset at points 0°, 120°, 180° and 300° in electric angle in the similar manner as the first embodiment. The offset value is 2Vc.

The comparative example is an ideal method in that the dead time compensation value is provided in just proportion. The motor inter-terminal voltage is thus provided. If the motor inter-terminal voltage Vuv between the U-phase and the V-phase in the first embodiment are compared, the both voltages are coincident if the offset value 3Vs in the first embodiment and the offset value 2Vc in the comparative example are equal to each other. For this reason, the ideal dead time compensation can be provided in the first embodiment as in the comparative example by satisfying the following equation.

Vs=2/3×Vc (2)

Thus, the ratio Vs/Vc is most appropriately 2/3 in theory. A preferred numeric range of the ratio Vs/Vc, which includes 2/3 that is, about 0.67, is described below.

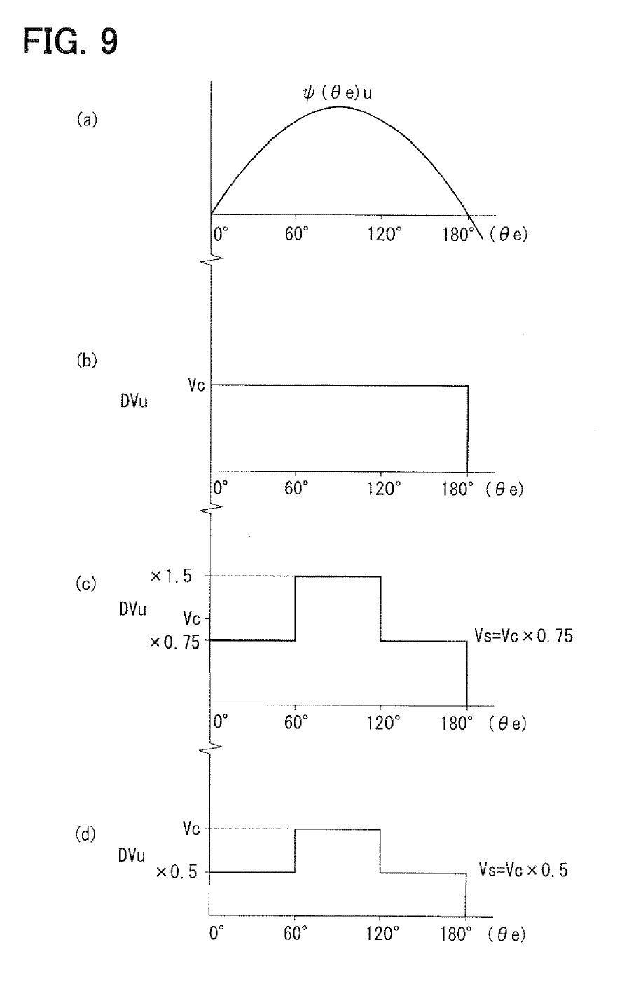

In FIG. 9, (a) shows the U-phase parameter ψ(θe)u in a range of electric angle between 0° and 180° and (b) shows the theoretical dead time compensation value Vc in the comparative example.

(c) shows a case, in which the reference, value Vs is set to be 0.75 times of the theoretical dead time compensation value Vc in the first embodiment. In this case, an integration value of the dead time compensation value DVu in the range between 0° and 180° equals an integration value of the theoretical dead time compensation value Vc. It is thus determined that sufficient dead time compensation can be provided. That is, the compensation becomes excessive if the ratio Vs/Vc exceeds 0.75. It is therefore appropriate to set a maximum value of the ratio Vs/Vc to 0.75.

(d) shows a case, in which the reference value Vs is set to be 0.5 times of the theoretical dead time compensation value Vc in the first embodiment. In this case, the dead time compensation value DVu in the range between 60° and 120° is two times of the reference value Vs and equals the theoretical dead time compensation value Vc. It is thus determined that dead time compensation in this range becomes insufficient if the ratio Vs/Vc is reduced to be less than 0.5. It is therefore appropriate to set a minimum value of the ratio Vs/Vc to 0.5.

For these reasons, the reference value Vs is preferably set to be in the range of 50% to 70% of the theoretical dead time compensation value Vc, and most preferably to about 67% of Vc.

### (Advantage)

In the comparative example, assuming that the theoretical dead time compensation value Vc is 1 in the range of 180° from one zero-cross point to the next zero-cross point, the dead time compensation value DV of the fixed value is provided at every 60° interval at a ratio of 1:1:1. According to the first embodiment of the present invention, however, assuming that the ratio Vs/Vc is 2/3, the dead time compensation value DV is provided at every 60° interval stepwise at a ratio of (2/3):(4/3):(2/3). Thus, the stepwise change in the dead time compensation value at the zero-cross point can be reduced to a relatively small value while realizing sufficient dead time compensation. The torque ripple near the zero-cross point can be suppressed. The switch-over timing of the dead time compensation value DV is readily controllable, because it is commanded by the parameter ψ(θe) such as the phase current detection value or the like.

In the electric power steering system, a small current range near the zero-cross point is a range, in which the steering wheel is turned from the neutral position to the steering direction. This range is most frequently used in normal travel operation. This range is also very susceptible to influence of dead time. Therefore, the electric power steering system is provided with a remarkable advantage by suppressing the torque ripple while realizing sufficient dead time compensation in this range.

This dead time compensation method does not increase a loop gain in the feedback control. As a result, motor vibration and generation of abnormal sound, which are caused by noise, can be suppressed. Merchantability of the electric power steering system can be ensured if the motor control method of the present invention is applied to the electric power steering system.

### Second Embodiment

The motor control apparatus, which performs a motor control method according to a second embodiment, is generally the same as the first embodiment. The motor control method according to the second embodiment is different from the first embodiment in that a present section is determined directly from an electric angle θe and not from the parameter of each phase.

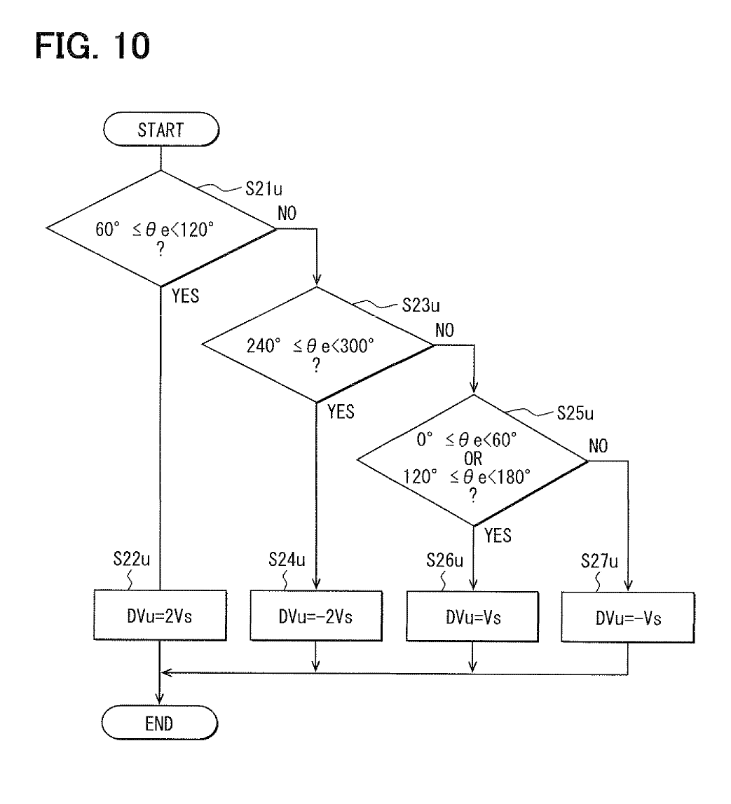

Dead time compensation values DVu, DVv and DVw of a U-phase, a V-phase and a W-phase are determined as shown in FIGS. 10, 11 and 12 in a motor control method according to the second embodiment, respectively.

The dead time compensation value DVu for the U-phase is determined as shown in the flowchart of FIG. 10. At S21u, it is checked whether the electric angle θe is equal to or greater than 60° and less that 120°. If the check result of S21u is YES, the first dead time compensation value DVu is set to 2Vs at S22u. If the check result of S21u is NO, S23u is executed. At S23u, it is checked whether the electric angle θe is equal to or greater than 240° and less than 300°. If the check result of S23u is YES, the second dead time compensation value DVu is set to −2Vs at S24u. If the check result of S23u is NO, S25u is executed. At S25u, it is checked whether the electric angle θe is equal to or greater than 0° and less than 60° or the electric angle θe is equal to or greater than 120° and less than 180°. If the check result of S25u is YES, the third dead time compensation value DVu is set to Vs at S26u. If the check result of S25u is NO, the fourth dead time compensation value DVu is set to −Vs at S27u.

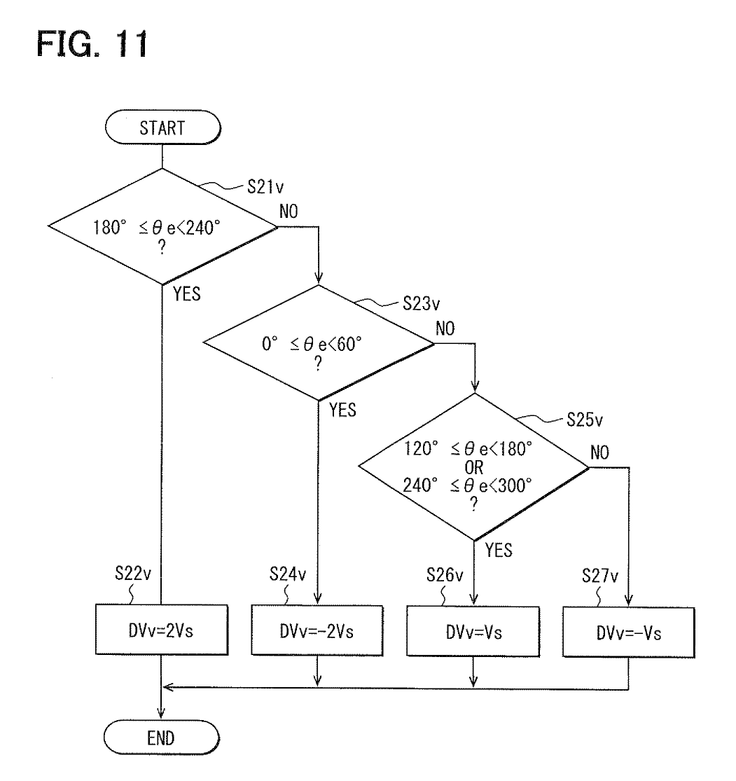

The dead time compensation value DVv for the V-phase is determined as shown in the flowchart of FIG. 11. At S21v, it is checked whether the electric angle θe is equal to or greater than 180° and less that 240°. If the check result of S21v is YES, the first dead time compensation value DVv is set to 2Vs at S22v. If the check result of S21v is NO, S23v is executed. At S23v, it is checked whether the electric angle θe is equal to or greater than 0° and less than 60°. If the check result of S23v is YES, the second dead time compensation value DVv is set to −2Vs at S24v. If the check result of S23v is NO, S25v is executed. At S25v, it is checked whether the electric angle θe is equal to or greater than 120° and less than 180° or the electric angle θe is equal to or greater than 240° and less than 300°. If the check result of S25v is YES, the third dead time compensation value DVv is set to Vs at S26v. If the check result of S27v is NO, the fourth dead time compensation value DVu is set to −Vs at S27v.

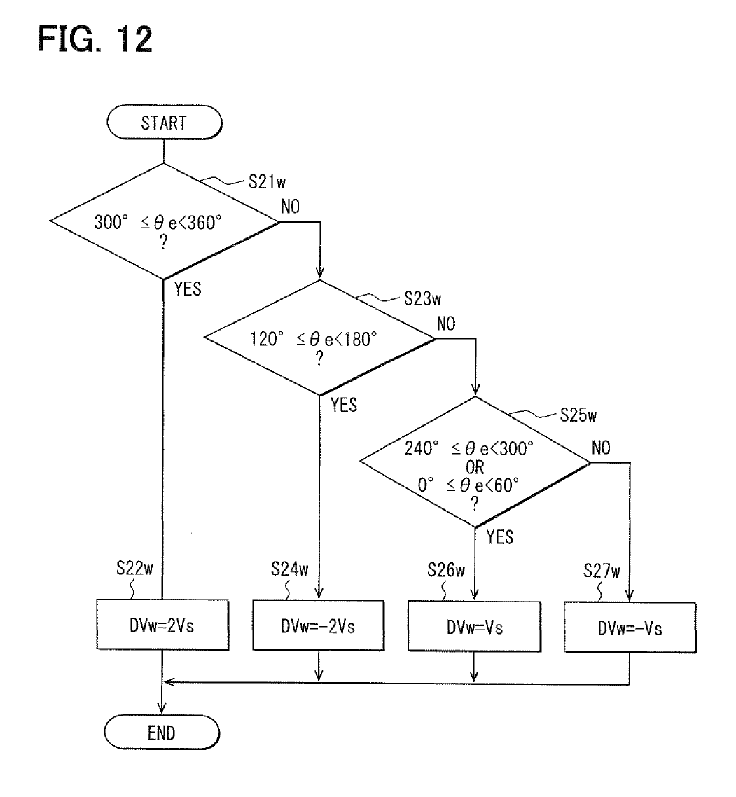

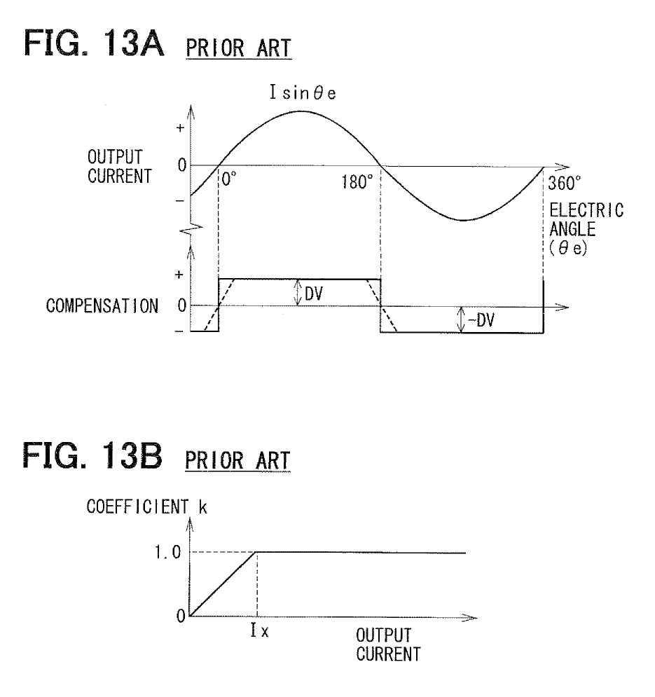

The dead time compensation value DVw for the W-phase is determined as shown in the flowchart of FIG. 12. At S21w, it is checked whether the electric angle θe is equal to or greater than 300° and less that 360°. If the check result of S21w is YES, the first dead time compensation value DVw is set to 2Vs at S22w. If the check result of S21w is NO, S23w is executed. At S23w, it is checked whether the electric angle θe is equal to or greater than 120° and less than 180°. If the check result of S23w is YES, the second dead time compensation value DVw is set to −2Vs at S24w. If the check result of S23w is NO, S25w is executed. At S25w, it is checked whether the electric angle θe is equal to or greater than 240° and less than 300° or the electric angle θe is equal to or greater than 0° and less than 60°. If the check result of S25w is YES, the third dead time compensation value DVw is set to Vs at S26u. If the check result of S25w is NO, the fourth dead time compensation value DVw is set to −Vs at S27w.

In the motor control method according to the second embodiment, the same dead time compensation values DVu, DVv and DVw are provided as in the first embodiment. The second embodiment thus provides the similar advantage as the first embodiment.

### Other Embodiments

The foregoing embodiments may be modified as follows.

(a) In the first embodiment, it is checked at S11u for example in the flowchart (FIG. 4) whether the parameter ψ(θe)u is equal to or greater than 0 and the parameters of other two phases, that is, ψ(θe)v and ψ(θe)w are both less than 0. It is noted that, although the point ψ(θe)=0 is treated as belonging to the same range as being greater than 0, it may be treated as belonging to the same range as being less than 0. This is only for the purpose of including ψ(θe)=0 in one of the two adjacent ranges without overlap. It may be included in any one of the ranges in practice.

(b) The order of execution of S11u and S13u shown in FIG. 4 may be reversed. It may be checked whether ψ(θe)u is equal to or less than 0 in place of S15u. In this case, the dead time compensation value DVu may be set to −Vs and Vs if the check result is YES and NO, respectively.

(c) In the second embodiment, it is checked in the flowcharts (FIGS. 10 to 12) whether the electric angle θe is equal to or greater than the low limit value and is less than the high limit value. In the similar manner as the modification (a), the electric angle θe may be greater than the low limit value and equal to or less than the high limit value.

(d) The order of execution of S21u, S23u, S25u and a step, which is for checking whether the electric angle θe is equal to or greater than 180° and less than 240° or θe is equal to or greater than 300° and less than 360° as a result of NO determinations at S21u, S23u and S25u, may be changed, in case of flowchart of the U-phase for example. This change of order of execution is also possible in case of flowchart of the V-phase and the W-phase.

The present invention is not limited to the disclosed embodiments but may be implemented in other different embodiments.

What is claimed is:

1. A motor control method for compensating an error voltage, which is caused between a PWM command value and an output voltage by a dead time of a voltage-type inverter for driving a three-phase AC motor, the motor control method comprising steps of:
(1) acquiring a predetermined parameter of each of three phases represented by sine waveforms, which have same amplitudes relative to a central value 0 and phases having phase differences of 120° one another in correspondence to a phase of electric angle, the parameter being calculated based on the electric angle of the motor in advance of generation of a PWM voltage;
(2) setting a first dead time compensation value, which is two times as large as a predetermined reference value, to increase the PWM command value of one phase in a case of a first condition that the parameter of the one phase is greater than 0 and the parameters of other two phases are both less than 0;
(3) setting a second dead time compensation value, which is set to be two times as large as the predetermined reference value, to decrease the PWM command value of the one phase in a case of a second condition that the parameter of the one phase is less than 0 and the parameters of the other two phases are both greater than 0;
(4) setting a third dead time compensation value, which is as large as the predetermined reference value, to increase the PWM command value of the one phase in a case that the parameter of the one phase is greater than 0 but different from the first condition;
(5) setting a fourth dead time compensation value, which is as large as the predetermined reference value, to decrease the PWM command value of the one phase in a case that the parameter of the one phase is less than 0 but different from the second condition; and
(6) outputting to the inverter a compensated PWM voltage, which is determined by adding the first or the third dead time compensation value to the PWM command value or subtracting the second or the fourth dead time compensation value from the PWM command value in correspondence to a value of the parameter,
wherein the steps of (4) and (5) are executed after execution of the steps (2) and (3).

2. The motor control method according to claim 1, wherein:
the predetermined parameter includes any one of a phase current detection value, the PWM command value, a phase current command value and a phase voltage command value.

3. The motor control method according to claim 1, wherein:
the reference value is set to be in a range between 50% and 75% of a theoretical dead time compensation value Vc, which is determined as Vc=t×f×Vb assuming that “t,” “f” and “Vb” a dead time, a PWM switching frequency and an inverter voltage, respectively.

4. A motor control apparatus comprising:
a control circuit, which is configured to perform a PWM conversion calculation operation for outputting the PWM command value, a motor electric angle calculation operation for outputting the electric angle and a motor control operation based on the motor control method according to claim 1.

5. An electric power steering system comprising:
the motor control apparatus according to claim 5.

6. A motor control method for compensating an error voltage, which is caused between a PWM command value and an output voltage by a dead time of a voltage-type inverter for driving a three-phase AC motor having a U-phase, a V-phase and a W-phase, the motor control method comprising steps of:
(1′) acquiring an electric angle of each of the U-phase, the V-phase and the W-phase, assuming that phase currents of the U-phase, the V-phase and the W-phase have same amplitudes relative to a central value 0, a sine waveform of a U-phase current increases from 0 at an electric angle θ°, a V-phase current is delayed 120° relative to the U-phase current and a W-phase current advances 120° relative to the U-phase current, and further assuming that the electric angle is divided into a first range, a second range, a third range, a fourth range, a fifth range and a sixth range, which are between 0° and 60°, between 60° and 120°, between 120° and 180′, between 180° and 240°, between 240° and 300° and between 300° and 360°, respectively;
(2′) setting a first dead time compensation value, which is two times as large as a predetermined reference value to increase the PWM command value of the U-phase in the second range, the PWM command value of the V-phase in the fourth range and the PWM command value of the W-phase in the sixth range, respectively;
(3′) setting a second dead time compensation value, which is two times as large as the predetermined reference value, to decrease the PWM command value of the U-phase in the fifth range, the PWM command value of the V-phase in the first range and the PWM command value of the W-phase in the third range, respectively;
(4′) setting a third dead time compensation value, which is as large as the predetermined reference value, to increase the PWM command value of the U-phase in the first range and the third range, the PWM command value of the V-phase in the third range and the fifth range and the PWM command value of the W-phase in the fifth range and the first range, respectively;
(5′) setting a fourth dead time compensation value, which is as large as the predetermined reference value, to decrease the PWM command value of the U-phase in the fourth range and the sixth range, the PWM command value of the V-phase in the sixth range and the second range and the PWM command value of the W-phase in the second range and the fourth range, respectively; and
(6′) outputting to the inverter a compensated PWM voltage, which is determined by adding the first or the third dead time compensation value to the PWM command value or by subtracting the second or the fourth dead time compensation value from the PWM command value in correspondence to a range of the electric angle.

7. The motor control method according to claim 6, wherein:
the reference value is set to be in a range between 50% and 75% of a theoretical dead time compensation value Vc, which is determined as Vc=t×f×Vb assuming that “t,” “f” and “Vb” a dead time, a PWM switching frequency and an inverter voltage, respectively.

8. A motor control apparatus comprising:
a control circuit, which is configured to perform a PWM conversion calculation operation for outputting the PWM command value, a motor electric angle calculation operation for outputting the electric angle and a motor control operation based on the motor control method according to claim 3.

9. An electric power steering system comprising:
the motor control apparatus according to claim 8.
